(19) United States
(12) Patent Application Publication
(10) Pub. No.: US 2024/0309611 A1
(43) Pub. Date: Sep. 19, 2024

(54) METHOD AND SYSTEM FOR CONTROLLING A PROPULSION SYSTEM OF A WORK OR AGRICULTURAL VEHICLE

(71) Applicant: CNH Industrial Italia S.p.A., Turin (IT)

(72) Inventors: SANTOLO ANTONIO CASILLO, Poggiomarino (NA) (IT); ADRIANO GARRAMONE, Lecce (IT); ANTONIO VENEZIA, Torino (IT); STEFANO LIBERTI, Lecce LE (IT); ANDREA GRAVILI, Lecce LE (IT)

(21) Appl. No.: 18/603,552

(22) Filed: Mar. 13, 2024

(30) Foreign Application Priority Data
Mar. 14, 2023 (IT) 102023000004806

(51) Int. Cl. E02F 9/22; B60K 23/00; B60K 26/00; B60K 31/02

(52) U.S. Cl. CPC E02F 9/2253; B60K 23/00; B60K 26/00; B60K 31/02; E02F 9/2246; E02F 9/2296

(57) ABSTRACT

A method of controlling a propulsion system of a work or agricultural vehicle, wherein the propulsion system includes a prime mover and a hydraulic transmission including a variable displacement pump configured to be driven in rotation by the prime mover and a variable displacement hydraulic motor, operatively connected to the pump by means of a forward hydraulic line and a return one, the method providing for an ECO operating mode in which the accelerator controls the displacement of the hydraulic pump while the engine is operated at a fixed speed and in which, in said ECO operating mode, there is a step for acquiring a current speed of the vehicle (Step 1) and a limiting step (Step 3) of said displacement of the hydraulic pump when said current speed is lower than a predetermined speed threshold.

### FIELD OF THE INVENTION

The present invention relates to the field of hydraulic transmissions of work vehicles and agricultural vehicles, in which the hydraulic transmission is driven by an internal combustion engine.

### STATE OF THE ART

In work and agricultural vehicles, the transmission for transferring the motion of a prime mover to the wheels is of the hydraulic type. Very often the transmission defines a series configuration, in which the prime mover drives a hydraulic pump with variable displacement, which, in turn, drives a hydraulic motor which can have both fixed and variable displacement.

The pump and the hydraulic motor are interconnected in a per se known way by means of a so-called high pressure hydraulic line or “forward” line and a low pressure hydraulic line or return line for the hydraulic oil towards the hydraulic pump.

A discrete ratio gearbox is often, but not always, placed between the hydraulic motor and the wheels. Very often there are just two ratios, to facilitate the autonomous movement of the vehicle from one workplace to another workplace.

Generally, the rotational speed of the prime mover is directly proportional to the position of the throttle lever and the pump displacement is proportional to the rotational speed of the prime mover, while the displacement of the hydraulic motor is inversely proportional to the vehicle speed.

Consequently, the speed of the vehicle and the rotational speed of the prime mover are approximately directly proportional to each other.

Consequently, the speed of the vehicle and the position of the accelerator lever are approximately directly proportional to each other.

This first operating mode is for convenience defined as “accelerator-base”, since the rotation speed of the prime mover is approximately directly proportional to the position of the accelerator lever and the vehicle speed depends on the rotation speed of the prime mover.

The term “about” highlights that the control is in open loop, therefore an increase in the slope causes the vehicle and also the prime mover to slow down.

This fact is very advantageous when the vehicle is working because the driver can manage the generation of hydraulic fluid necessary to operate the various on-board devices functional to the workings with the accelerator lever.

When the vehicle, however, moves from one workplace to another, the fuel consumption can be excessive and therefore the applicant has provided a method for managing the engine and the hydraulic transmission with application EP21183330, according to which the engine speed is fixed when operating in ECO mode.

In the following, “speed of the prime mover” means the “rotation speed of the prime mover”.

The Applicant has implemented in its private laboratories a solution according to which an engine speed limit is set, selected so as to minimize fuel consumption. Furthermore, it is envisaged to operate the vehicle in the “accelerator-base” operating mode for engine rotation speeds below the limit speed and to automatically switch to an “ECO” mode when the engine rotation speed reaches the limit speed. By pressing the accelerator level further, in ECO mode, the engine speed remains fixed at the limit speed, while a proportionality is maintained only between the position of the accelerator level and the displacement of the hydraulic pump, allowing the vehicle to exceed the speed which it would achieve in accelerator-base mode.

When the vehicle is in ECO mode, the hydrostat control operates directly according to the position of the accelerator lever rather than according to the engine speed, thanks to a sort of mapping of the positions of the accelerator lever starting from the position corresponding to the engine switching speed from accelerator-base mode to ECO mode, to full stroke lever position.

Regardless of how the activation of the ECO mode is decided, the applicant has noted that, during the experimentation, when the vehicle inserts the bucket into a pile of material to be picked up, commonly referred to as “digging”, while in ECO mode, the vehicle drive wheels spin excessively. In fact, the operator is naturally inclined to press the accelerator pedal thinking he is helping the vehicle to make the bucket penetrate the pile, however, the engine rotation speed is fixed and therefore the accelerator position only affects the pump displacement that proportionally increases. As a result, the prime mover is overloaded and the wheels of the vehicle slip at the same time.

Unless specifically excluded in the detailed description that follows, what is described in this chapter is to be considered as an integral part of the detailed description.

### SUMMARY OF THE INVENTION

The object of the present invention is to prevent the wheels of the vehicle from slipping when, in ECO mode, it encounters an obstacle which suddenly slows down the vehicle.

More specifically, the purpose is to prevent the wheels of the vehicle from slipping when, in ECO mode, it inserts the bucket into a pile of material to be picked up.

The basic idea of the present invention is to monitor the vehicle speed and to prevent the hydraulic pump displacement from exceeding a first predetermined displacement threshold when the vehicle speed is lower than a second predetermined speed threshold.

In fact, it has been found that in the instants preceding the digging operation, the vehicle moves quite slowly and therefore the complete depression of the accelerator lever is considered incompatible with a low speed and therefore, it is possible to solve the above problem according to the present invention.

In ECO mode, i.e. with the engine operating at an approximately fixed speed, the possible positions of the accelerator lever are mapped so as to allow the vehicle to reach speeds higher than the vehicle speed corresponding to the engine rotation speed in accelerator-base mode. Preferably, in ECO mode, a feedback control is activated which controls the displacement of the hydraulic motor and/or hydraulic pump as a function of the position of the throttle lever to bring the vehicle speed to the mapped speed, corresponding to the current position of the accelerator lever.

The purpose is to keep the engine at a pre-set rotation speed, acting exclusively on the transmission.

According to the present invention, the maximum displacement which the hydraulic pump can assume is reduced to a fixed value when the speed of the vehicle is lower than the aforementioned second speed threshold.

Preferably, a limitation is also made on the displacement of the hydraulic motor, which cannot decrease beyond a predetermined third threshold when the vehicle speed is lower than the aforementioned second speed threshold. In this case, a combined effect of a limitation on both the hydraulic pump and the hydraulic motor is obtained.

In parallel with the limitations based on the vehicle speed threshold, the pressure on the hydrostat hydraulic high pressure line can also be monitored, further limiting the hydraulic pump displacement when the current pressure value exceeds a fourth pressure threshold.

The dependent claims describe preferred variants of the invention, forming an integral part of the present description.

### BRIEF DESCRIPTION OF THE FIGURES

Further objects and advantages of the present invention will become clear from the detailed description that follows of an embodiment of the same (and of its variants) and from the annexed drawings given for purely explanatory and non-limiting purposes, in which:

FIG. 1 shows an example of a propulsion scheme of a work or agricultural vehicle in which the present invention is implemented;

FIG. 2 shows an example of a work vehicle implementing the propulsion scheme of FIG. 1;

FIG. 3 shows an exemplary flow diagram of the method of the present invention, implemented in the diagram of FIG. 1. The blocks shown in dotted lines are optional.

The same reference numbers and letters in the figures identify the same elements or components or functions.

In the context of this description, the term “second” component does not imply the presence of a “first” component. These terms are in fact used as labels to improve clarity, having no ordinal meaning unless it is clear from the text that there is a precise order to be respected.

The elements and characteristics illustrated in the various preferred embodiments, including the drawings, can be combined with each other without however departing from the scope of protection of the present application as described below.

### DETAILED DESCRIPTION

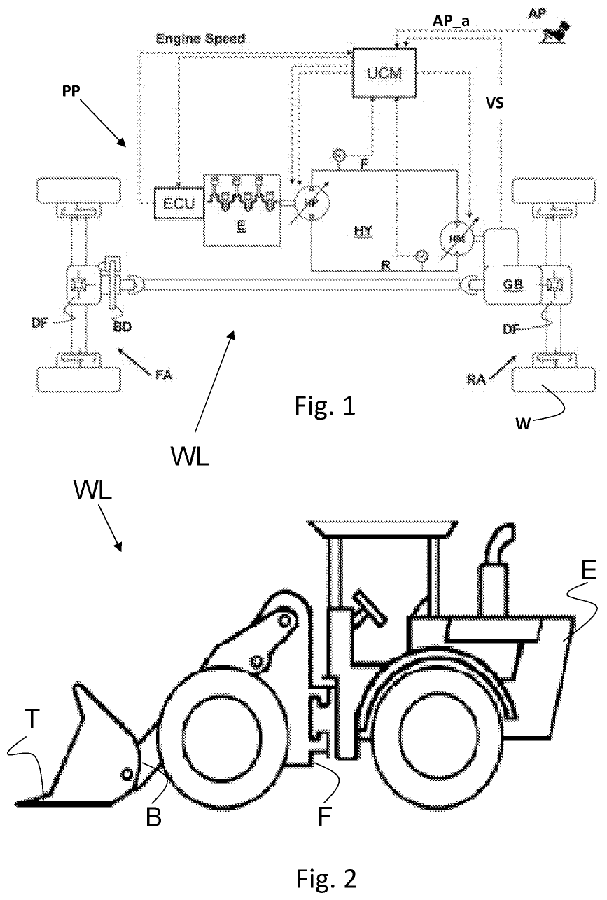

FIG. 1 shows a propulsion system diagram of a work or agricultural vehicle WL.

The propulsion system comprises a prime mover E, generally an internal combustion engine, for example diesel or spark ignited.

The prime mover is configured to drive in rotation a variable geometry hydraulic pump HP, which feeds a hydraulic motor HM, for vehicular propulsion, by means of a forward or high pressure hydraulic line F and a return or low pressure hydraulic line R.

The hydraulic motor has a shaft operatively associated with a driving axle RA of the vehicle.

Preferably, this association is achieved by means of a discrete ratio gearbox GB. Generally, the secondary shaft of the gearbox GB rotates a port of a differential DF, to rotate the two axle shafts of the driving axle RA. The configuration shown in FIG. 1 has four driving wheels, so that a rear driving axle RA and a front driving axle FA are identified.

The configuration shown, in itself is known.

According to a preferred variant of the present invention, the hydraulic pump can be controlled independently of the rotation speed of the prime mover which drives the same pump in rotation. More preferably, the hydraulic motor has a variable displacement and can be controlled independently of the hydraulic pump by means of respective electro-hydraulic valves, not shown.

An engine control processing unit ECU controls the operation of the prime mover.

A vehicle processing unit UCM interfaces with the engine control processing unit ECU and controls the hydraulic transmission HY as well as monitors the position of levers, buttons and man/machine interface commands, both in relation to vehicle movement and in relation to the functioning of arms and organs connected to the vehicle.

AP indicates the accelerator pedal. Associated with the accelerator pedal or lever is a position sensor arranged to generate a signal AP_a representative of the position of the accelerator lever.

The existence of two distinct processing units is entirely optional. A single processing unit can control both the prime mover and all other vehicle functions and can monitor the activation of commands by the operator.

The present invention is preferably implemented in the vehicle processing unit UCM, but nothing prevents it from being implemented in the ECU.

Engine speed can be measured in any way, for example by the so-called phonic wheel associated with the crankshaft (not shown).

As vehicle speed increases, the displacement of the hydraulic pump increases, while the displacement of the hydraulic motor decreases.

The inverse proportionality between the value of the hydraulic pump displacement and the value of the hydraulic motor displacement can be tabulated according to a prearranged control strategy.

According to the present invention, the accelerator lever controls the rotational speed of the prime mover in the accelerator-base operating mode. The displacement of the hydraulic pump and preferably also of the hydraulic motor varies according to the rotation speed of the engine. In particular, the displacement of the hydraulic pump increases proportionally to the rotation speed of the engine, while the displacement of the hydraulic motor decreases proportionally as the speed of the vehicle increases.

According to the present invention, in ECO mode, the throttle lever only controls the displacement of the hydraulic pump and/or the hydraulic motor, while the motor is operated at a fixed rotational speed.

According to the present invention, when the vehicle operates in ECO mode, the displacement of the hydraulic pump is limited above a first predetermined displacement threshold when the vehicle speed is lower than a second predetermined speed threshold.

On the other hand, when the vehicle speed exceeds the second predetermined speed threshold, then the displacement of the hydraulic pump is function exclusively of the position of the accelerator lever, therefore the first displacement threshold is eliminated.

Preferably, at least one of the first displacement threshold and the second speed threshold can be calibrated.

The first displacement threshold is selected so as to prevent the wheels of the vehicle from slipping.

FIG. 2 shows a work vehicle WL equipped with an arm B operatively hinged to a vehicle chassis F. The arm pivotally supports a bucket T.

In FIG. 2, the vehicle is shown in the digging position, i.e. to insert the bucket into a pile of material to be picked up.

By virtue of the present invention, when the vehicle is driven to pick up material, wheel slip and prime mover overload are prevented.

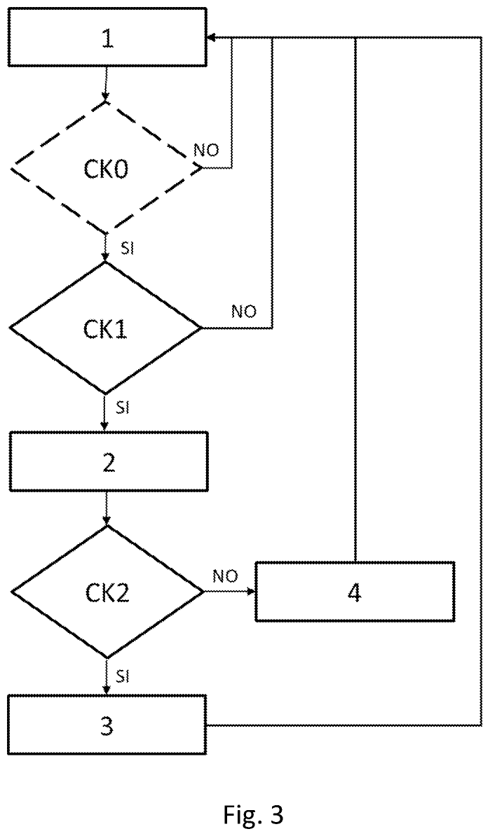

FIG. 3 shows an exemplary flow diagram of the method object of the present invention:
Step 1: acquisition of the current operating condition,
CK1: if the current operating condition is ECO mode, go to Step 2, otherwise go back to Step 1;
Step 2: vehicle speed acquisition;
CK2: if the vehicle speed is below the threshold ST, then
Step 3: setting a limit threshold of hydraulic pump displacement CT; otherwise,
Step 4: Elimination of said limit threshold of the hydraulic pump displacement.

The method is executed cyclically.

It is evident that the elimination of the displacement limit threshold CT means that the displacement of the hydraulic pump can reach the relative constructive limit value.

The speed of the vehicle can be acquired in various ways, almost all using a sensor located along the transmission.

It is clear that if the wheels are slipping, the measured speed would be wrong, as the vehicle would be attributed a speed that depends on the slipping rather than on the vehicle's actual motion. It is clear that the processing means first carry out the steps for acquiring/monitoring the vehicle parameters, including the vehicle speed, and subsequently carry out a check. This delay, implicit in any control system, guarantees that this method works, since the current speed is actually acquired at a sampling time prior to that of the control carried out on the hydraulic pump displacement.

As described above, switching from accelerator-base mode to ECO mode can take place as described in application EP21183330 or according to the solution tested in the applicant's private laboratories which provides for automatic switching to ECO mode when the engine speed reaches a predetermined speed of rotation.

According to a further preferred variant of the invention, it is also checked, at step CK0, whether the selector for forward gear is selected.

FIG. 3 shows that checks CK0 and CK1 are performed in succession. However, this is not necessary, as checking that the forward gear selector is set and that the current operating mode is ECO can be done in any order and even simultaneously.

It is worth highlighting that Steps 1 and 2 can be performed simultaneously and therefore also checks CK0, CK1 and CK2 can be performed in any order and also simultaneously.

The present invention can advantageously be implemented through a computer program comprising coding means for carrying out one or more steps of the method, when this program is executed on a computer. Therefore it is understood that the scope of protection extends to said computer program and also to computer-readable means comprising a recorded message, said computer-readable means comprising program coding means for carrying out one or more steps of the method, when said program is run on a computer.

Variants of the non-limiting example described are possible, without however departing from the scope of protection of the present invention, including all equivalent embodiments for a person skilled in the art, to the contents of the claims.

From the description given above, the person skilled in the art is capable of realizing the object of the invention without introducing further constructive details.

1. A method for controlling a propulsion system of a work or agricultural vehicle, wherein the propulsion system comprises a prime mover and a hydraulic transmission comprising a pump with variable displacement configured to be driven in rotation by the prime mover and a variable displacement hydraulic motor, operatively connected to the pump by means of a forward hydraulic line and a return line, the method providing:
a first operating mode, in which an inclination of an accelerator lever indicates a proportional rotation speed of the prime mover and a corresponding proportional displacement of the hydraulic pump and
a second operating mode, in which said inclination of the lever indicates a speed of the vehicle, while the prime mover is operated at a predetermined approximately fixed limit speed and the displacement of the hydraulic pump is regulated in such a way to reach said indicated vehicle speed,
the method, in said second operating mode, comprising a step (Step 1) of acquiring a current speed of the vehicle and a step (Step 3) of limiting said displacement of the hydraulic pump when said current speed is lower than a predetermined speed threshold.

2. Method according to claim 1, wherein said limitation (Step 3) of the hydraulic pump displacement is achieved by setting a limit displacement threshold, selected so as to prevent a slip of a wheel of the vehicle propulsion system.

3. Method according to claim 1, wherein said first limit threshold can be set by man/machine interface means.

4. Method according to claim 1, wherein said predetermined speed threshold can be set by means of said man/machine interface means.

5. Method according to claim 1, comprising in cyclical succession:
(Step 1) monitoring the current operating condition,
(CK1) if the current operating condition is ECO mode, go ahead (to Step 2), otherwise go back (to Step 1);
(Step 2) vehicle speed acquisition;
(CK2) if the vehicle speed is lower than the speed threshold, then
(Step 3) setting of a displacement limit threshold of the hydraulic pump; otherwise,
(Step 4) elimination of said limit threshold of the hydraulic pump displacement.

6. The method according to claim 1, comprising a step (CK0) of further checking whether the travel direction selector is set to forward, if so, then going ahead with the checking the current operating condition (CK1), otherwise returning to the monitoring of the current operating condition.

7. A computer program comprising program coding means adapted to carry out all steps (1-4) of claim 1, when said program is run on a computer.

8. A computer readable means comprising a recorded program, said computer readable means comprising a program coding means adapted to carry out all steps (1-4) of claim 1, when said program is run on a computer.

9. Work or agricultural vehicle comprising a propulsion system comprising a prime mover and a hydraulic transmission comprising a variable displacement pump configured to be driven in rotation by the prime mover and a hydraulic motor with variable displacement, operatively connected to the pump by means of a forward and a return hydraulic line, the propulsion system being adapted to operate according to
a first operating mode, wherein an inclination of an accelerator lever indicates a proportional rotation speed of the prime mover and a corresponding proportional displacement of the hydraulic pump and
a second operating mode, wherein said inclination of the lever indicates a speed of the vehicle, while the prime mover is operated at a predetermined approximately fixed limit speed and the displacement of the hydraulic pump is regulated in such a way to reach said indicated vehicle speed,
the system comprising processing means configured to, in said second operating mode, acquire a current speed of the vehicle and, consequently, to limit said displacement of the hydraulic pump when said current speed is lower than a predetermined speed threshold.
